(19) United States
(12) Patent Application Publication
(10) Pub. No.: US 2013/0314172 A1
(43) Pub. Date: Nov. 28, 2013

(54) Broadband Magic Tee

(71) Applicant: Government of the United States, as represented by the Secretary of the Air Force, Wright-Patterson AFB, OH (US)

(72) Inventor: Jeffrey P. Massman, Niceville, FL (US)

(73) Assignee: Government of the United States, as represented by the Secretary of the Air Force, Wright-Patterson AFB, OH (US)

(21) Appl. No.: 13/903,519

(22) Filed: May 28, 2013

Related U.S. Application Data
(60) Provisional application No. 61/651,733, filed on May 25, 2012.
(60) Provisional application No. 61/655,080, filed on Jun. 4, 2012.

(51) Int. Cl. H01P 5/20

(52) U.S. Cl. CPC H01P 5/20
USPC 333/122

(57) ABSTRACT

Embodiments of the invention provide a hybrid tee waveguide structure including a first collinear arm having a first waveguide, a second collinear arm having a second waveguide, an H-arm having a third waveguide and including at least one window; and an E-arm having a fourth waveguide and including at least one window, the E-arm oriented perpendicular to the H-arm. The first, second, third and fourth waveguides join at a common junction. The at least one window of the H-arm and the at least one window of the E-arm are proximate the common junction. The at least one window of the H-arm and the at least one window of the E-arm change an impedance of the common junction to reduce reflections in the H-arm and E-arm. The hybrid tee waveguide structure further includes an impedance matching element positioned in the common junction.

### CROSS-REFERENCE TO RELATED APPLICATIONS

This application claims the benefit of and priority to U.S. Provisional Application Serial No. 61/651,733, entitled “Broadband Folded E-Plane Magic-Tee,” filed on May 25, 2012, and U.S. Provisional Application Ser. No. 61/655,080, entitled “Broadband Folded E-Plane and H-Plane Magic-Tees,” filed on Jun. 4, 2012, the entireties of which are incorporated by reference herein.

### RIGHTS OF THE GOVERNMENT

The invention described herein may be manufactured and used by or for the Government of the Untied States for all governmental purposes without the payment of any royalty.

### BACKGROUND OF THE INVENTION

1. Field of the Invention

The present invention generally relates to waveguides and, more particularly, hybrid junction waveguides.

2. Description of the Related Art

A hybrid-tee waveguide (magic-tee) junction generally includes an intersection of four rectangular waveguides. Two mutually orthogonal waveguide sections, cross-polarized, have their centerlines in the symmetry plane of the waveguide junction. One of the mutually perpendicular waveguides is designated as the E-arm and the other as the H-arm, corresponding to the relation between the longitudinal axes of each waveguide and the electric field vector (\vec{E}) and the magnetic field vector (\vec{H}) of the third and fourth waveguide sections. The remaining two waveguides are formed by extending the bifurcation of the E-arm waveguide into the plane of symmetry at the junction mutual to all the waveguides. These two waveguide section are commonly referred to as the collinear arms. The folded E-plane and H-plane configurations may be obtained by bending the collinear arms back so that their centerlines are parallel to that of the E-arm and H-arm, respectively.

A waveguide hybrid junction fundamentally is an ideally lossless four-port, 180 degree hybrid power splitter. The device is constructed such that the power incident at either the E-arm or H-arm divides equally into the two collinear arms. Energy supplied simultaneously to both the E-and H-arms is distributed between the two collinear arms based on the relative amplitudes and phases of the input signals. Additionally, high isolation is maintained between the E- and H- arms with ideally no energy coupling between the two arms. Conversely, two coherent signals input into the collinear arms will produce their vector sum and difference at the other two H- and E-arms respectively.

Approaching the ideal performance of the waveguide hybrid junction over an appreciable range of frequencies generally requires specialized impedance matching elements. It is well known that waveguide hybrid junction design depends on exclusively maintaining device symmetry and simultaneously eliminating E- and H-arm signal reflections. In general, impedance matching may be obtained by inserting fundamentally inductive or capacitive based elements in E- and H-arms or the waveguide junction. Previous attempts at compensating the waveguide hybrid junction relied on various configurations of windows and rods to achieve matching across a limited range of frequencies. Additionally, some configurations refrained from any matching elements in pursuit of maximizing power handling capacity and instead relied on waveguide stepped-impedance transformers at the junction. Even with these efforts, contemporary magic tee configurations are generally limited to operating in 10-15 percent of operational waveguide bandwidth.

Accordingly, there is a need in the art for an improved magic tee configuration giving a broader operating bandwidth.

### SUMMARY OF THE INVENTION

Embodiments of the invention provide a hybrid tee waveguide structure including a first collinear arm having a first waveguide, a second collinear arm having a second waveguide, an H-arm having a third waveguide and including at least one window, and an E-arm having a fourth waveguide and including at least one window, the E-arm oriented perpendicular to the H-arm. The first, second, third and fourth waveguides join at a common hybrid junction. The at least one window of the H-arm and the at least one window of the E-arm are proximate the common junction. The windows of the H-arm and the windows of the E-arm change an impedance of the common junction to reduce reflections in the H-arm and E-arm.

In some embodiments, the hybrid tee waveguide structure of claim 1 further includes an impedance matching element positioned in the common junction and orthogonal to and extending toward the third waveguide. The impedance matching element is offset from a centerline of the E-arm and aligned with a centerline of the H-arm. In some of these embodiments, the impedance matching element includes a plurality of cylinders of different radii tapering toward the third waveguide. In a particular embodiment, the impedance matching element consists of five cylinders.

In other embodiments, the first and second collinear arms are oriented parallel to each other and parallel to the E-arm. In these embodiments, the hybrid tee waveguide structure further includes a bifurcating wall separating the first and second collinear arms and a stepped ridge profile extending from the bifurcating wall into the third waveguide in the H-arm and the fourth waveguide in the E-arm.

Some of the embodiments include waveguides having a rectangular cross section. In some specific embodiments, the rectangular cross section has a ratio of 2:1.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary embodiment of a magic-tee utilizing rectangular waveguides;

FIG. 2 is a perspective cut view along symmetry plane 3-3 exposing a waveguide junction of the magic-tee of FIG. 1;

FIG. 3 is a side view cut along symmetry plane 3-3 exposing impedance matching elements in the E- and H-arms of the magic-tee of FIG. 1;

FIG. 3A is a detailed view of the impedance matching elements of FIG. 3 ;

FIG. 4 is a side view cut along plane 4-4 exposing E-arm matching elements of the magic-tee of FIG. 1;

FIG. 4A is a detailed view of the matching elements of FIG. 4;

FIG. 4B is a detailed view of the stepped cone matching element of FIG. 4A;

FIG. 5 is a top view cut along plane 5-5 exposing internal impedance matching elements of the magic-tee of FIG. 1;

FIG. 5A is a detailed view of the impedance matching elements of FIG. 5;

FIG. 5B is a detailed view of the stepped cone matching element of FIG. 5A;

FIG. 6 is a perspective view of an alternate embodiment of a folded E-plane magic-tee utilizing rectangular waveguides;

FIG. 7 is a perspective cut view along symmetry plane 8-8 exposing a waveguide junction of the magic-tee of FIG. 6;

FIG. 8 is a side view cut along plane 8-8 exposing a multiple stepped ridge profile of the magic-tee of FIG. 6;

FIG. 8A is a detailed view of the multiple stepped ridge profile of FIG. 8;

FIG. 9 is a top view cut along plane 9-9 exposing internal matching elements of the magic-tee of FIG. 6;

FIG. 9A is a detailed view of the multiple stepped ridge profile of FIGS. 8 and 9;

FIG. 10 is a front view cut along plane 10-10 at a center point of the H-arm exposing inductive iris tuning elements of the magic-tee of FIG. 6;

FIG. 11 is a perspective view of an alternate embodiment of a folded H-plane magic-tee utilizing rectangular waveguides;

FIG. 12 is a perspective cut view along symmetry plane 14-14 exposing a waveguide junction of the magic-tee of FIG. 11;

FIG. 13 is a top view cut along plane 13-13 exposing internal impedance matching elements of the magic-tee of FIG. 11;

FIG. 13A is a detailed view of a cavity of FIG. 13;

FIG. 13B is a detailed top view of a quarter of the stepped conducting cone of FIG. 13;

FIG. 14 is a side view cut along plane 14-14 exposing a profile of a stepped conducting cone of the magic-tee of FIG. 11;

FIG. 15 is a front view cut along plane 15-15 exposing a different profile of the stepped conducting code of the magic-tee of FIG. 11;

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

A magic-tee is a type of 180 degree hybrid junction, four port device which provides a sum and difference of signals from its two input ports at its two output ports. In conventional form, the magic-tee consists of a waveguide E-plane and H-plane junction, placed mutually perpendicular and intersecting to form symmetry about a specified plane. The combined structure is generally called a hybrid-T junction, where two of the arms are mirror images of each other with respect to the place of symmetry, commonly denoted as collinear arms. Additionally, the remaining two arms lie cross-polarized along a centerline of the symmetry plane and are regarded as either the E-arm or H-arm.

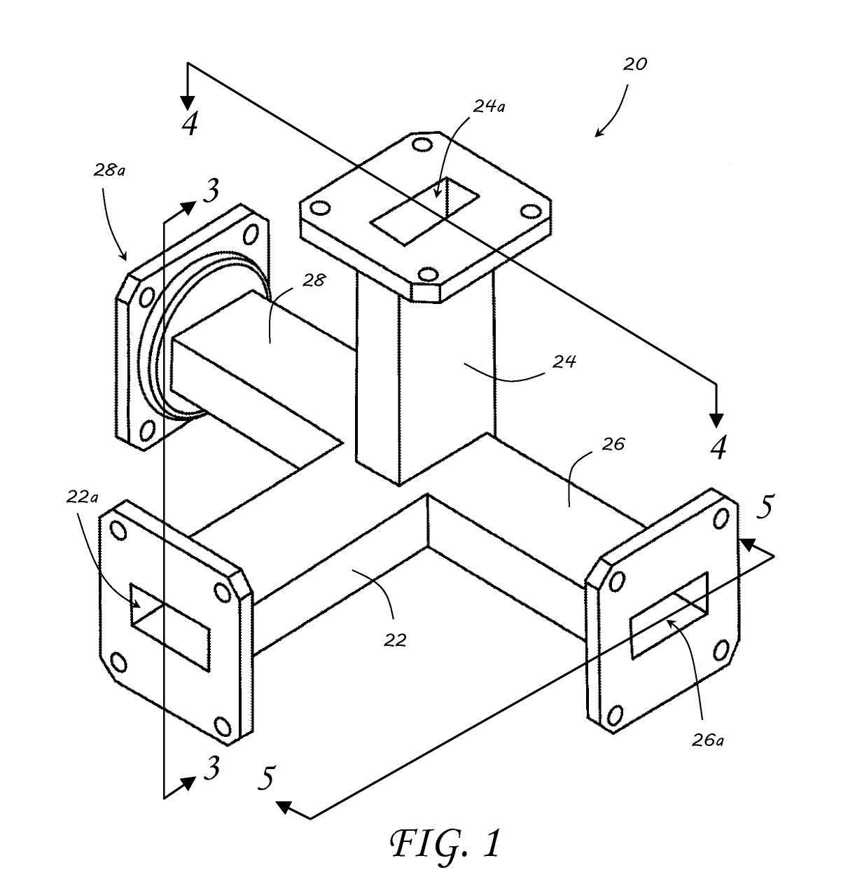

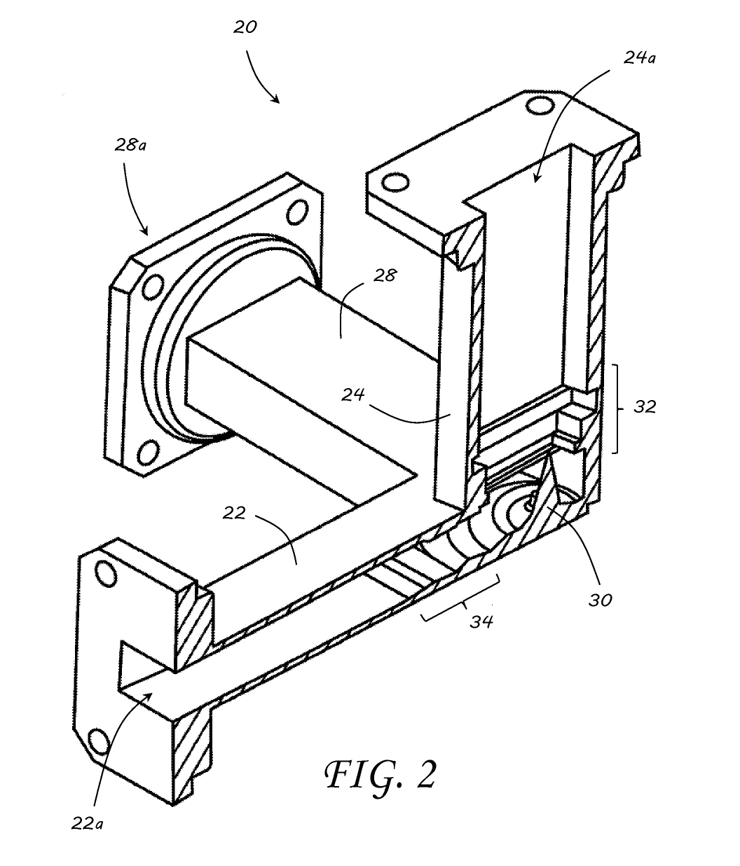

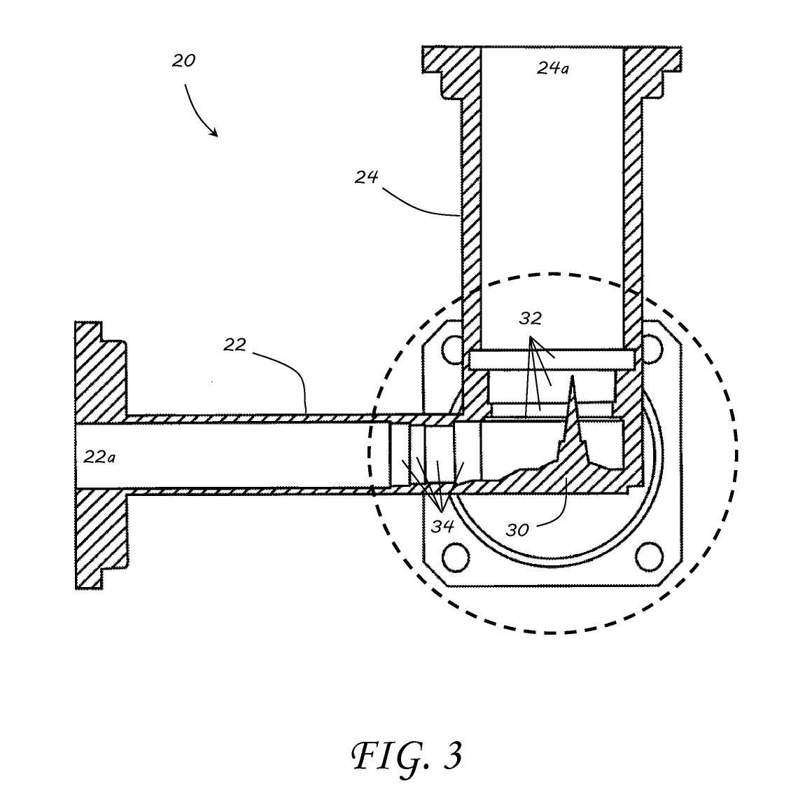

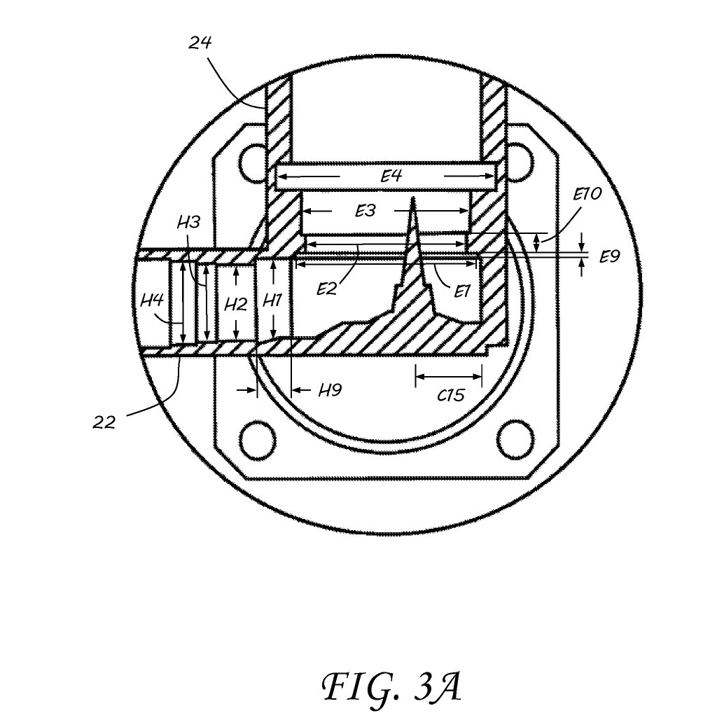

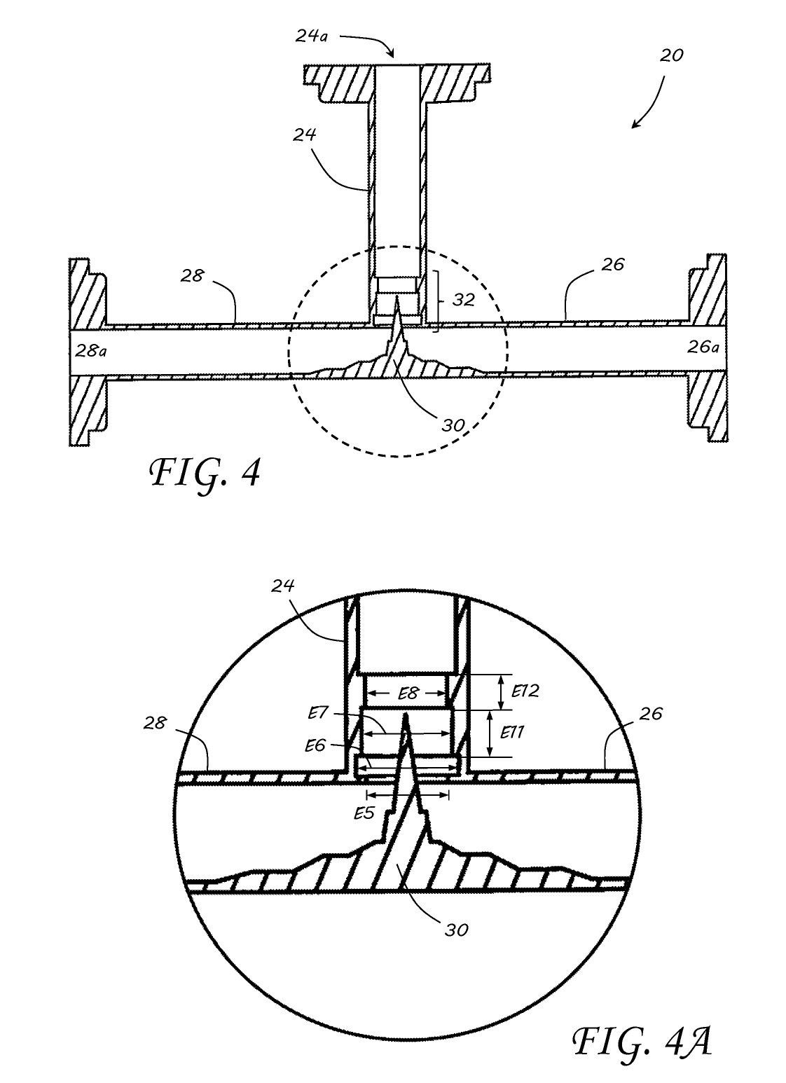

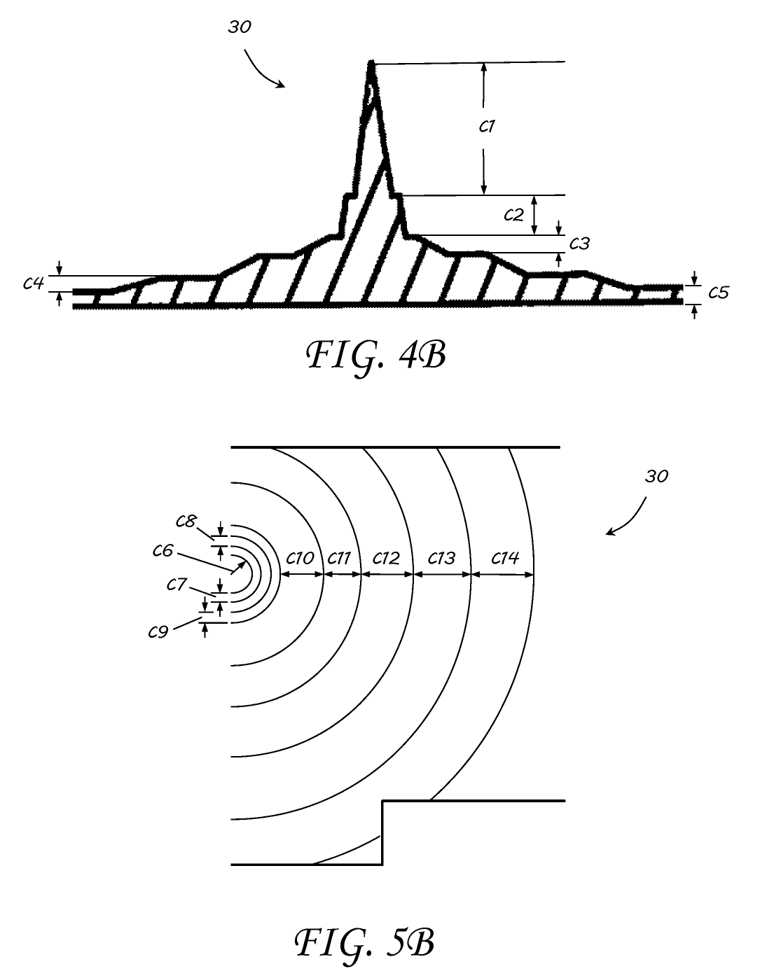

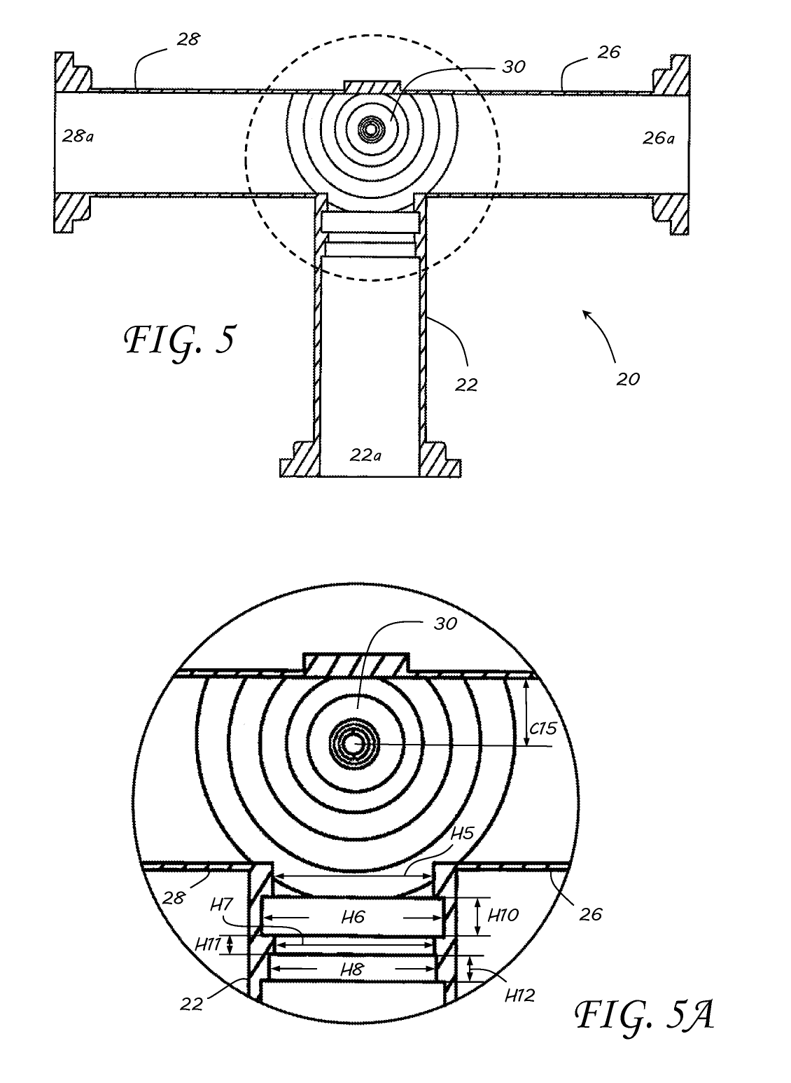

Turning now to the drawings, FIG. 1 illustrates a magic-tee 20 consistent with embodiments of the invention. Embodiments of the invention improve the operational bandwidth of the magic-tee 20 by maintaining a geometric symmetry about a designated plane and simultaneously minimizing reflections in an H-arm 22 and an E-arm 24. These two design criteria are met by use of a matching element design to obtain wideband reduction in a return loss of ports 22a, 24a, 26a, and 28a associated with each arm 22, 24, 26, and 28. An exemplary structure used in the illustrated embodiment of magic-tee 20 includes an off-centered stepped conducting cone 30 coupled to cascaded windows 32, 34 along the E- and H-arms 24, 22. Details of the stepped cone 30 may be seen in various orientations in FIGS. 2, 3, 3A, 4, 4A, 4B, 5, 5A, and 5B. Dimensions of the stepped cone (C1-C15) normalized to a center frequency are set out the Table below:

TABLE 1
Frequency Normalized Stepped Conducting Cone Dimensions

| Cone Dimension | Frequency Normalized Value |
|---|---|
| C1 | 0.338339 |
| C2 | 0.102958 |
| C3 | 0.042191 |
| C4 | 0.056734 |
| C5 | 0.031865 |
| C6 | 0.043953 |
| C7 | 0.017706 |
| C8 | 0.022935 |
| C9 | 0.014046 |
| C10 | 0.096082 |
| C11 | 0.086139 |
| C12 | 0.115717 |
| C13 | 0.129802 |
| C14 | 0.135681 |
| C15 | 0.110488 |

In this exemplary embodiment, the stepped conducting cone 30 consists of five steps, though other embodiments may have more or fewer steps.

The windows 32, 34 along each waveguide arm act as reactive elements, which assist in matching the waveguide impedance to a junction impedance. The windows act as symmetrical diaphragms along both narrow and broad walls of the waveguide to create a series of shut inductive and capacitive elements. The illustrated embodiment contains four windows in the E-arm 24 and the H-arm 22. Other embodiments may contain more or fewer windows in each of the arms. In other embodiments the number of windows in the E-arm 24 may be greater or fewer than the number of windows in the H-arm 22. Details of the E-arm 24 and H-arm windows may be seen in various orientations in FIGS. 2, 3, 3A, 4, 4A, 4B, 5, 5A, and 5B. Dimensions of these windows normalized to a center frequency are set out the Tables below:

TABLE 2
Frequency Normalized E-arm Window Dimensions

| E-arm Window | Frequency |
|---|---|
| Dimensions | Normalized Value |
| E1 | 0.726043 |
| E2 | 0.641772 |
| E3 | 0.672371 |
| E4 | 0.876502 |
| E5 | 0.139228 |
| E6 | 0.178407 |
| E7 | 0.158510 |
| E8 | 0.143679 |
| E9 | 0.018818 |
| E10 | 0.077777 |
| E11 | 0.167139 |
| E12 | 0.106604 |

TABLE 3
Frequency Normalized H-arm Window Dimensions

| H-arm Window | Frequency |
|---|---|
| Dimensions | Normalized Value |
| H1 | 0.146173 |
| H2 | 0.156376 |
| H3 | 0.080858 |
| H4 | 0.109517 |
| H5 | 0.641959 |
| H6 | 0.767809 |
| H7 | 0.667616 |
| H8 | 0.678784 |
| H9 | 0.169333 |
| H10 | 0.148981 |
| H11 | 0.152039 |
| H12 | 0.164607 |

Overall geometric symmetry is maintained over the cut plane 3-3 for all matching elements. Additionally, the four waveguides in arms 22, 24, 26, and 28 in the illustrated embodiment are rectangular in cross section with dimensional ratio of approximately 2 to 1, though other embodiments may utilize waveguides having cross sections with alternate ratios, or cross sections that are not rectangular. The exact dimensions of the waveguides in arms 22, 24, 26, and 28 may be determined with respect to an excitation frequency such that a fundamental TE₁₀ mode may propagate in the waveguides. In the illustrated embodiment, the waveguides were designed for an excitation frequency of approximately 10 GHz.

The illustrated embodiment was optimized for X-band applications or WR90 waveguide standards (a=0.9 in, b=0.4 in), though other embodiments may be optimized for other applications. The illustrated embodiment was simulated in an electromagnetic simulation software package, such as ANSYS HFSS by Ansys, Inc. of Canonsburg, Pa. The embodiment was optimized utilizing a genetic algorithm with roulette wheel selection and with a crossover rate of 0.9 and mutation rate of 0.15. The algorithm was applied to the dimensions of the stepped conducting cone 30 and the windows along both the E- and H-arms 24, 22. A cost function applied to the genetic algorithm process is defined as:

$$Cost = {\sum }_{i = 1.4}^{ } {\sum }_{n = 1}^{N} {\vert max [ 0 , {S}_{ii} ( {f}_{n} ) - {S}_{obj} ] \vert}^{2} , \qquad ( 1 )$$

Where Sᵢᵢ(fₙ) is a return loss at the i-th waveguide port number at a test frequency fₙ (8.2-12.4 GHz for X-band), and S_{obj} is an objective return loss of −20 dB. The return loss at ports 26a and 28a are not considered because maintaining symmetrical geometry while simultaneously reducing E- and H-arm 24, 22 reflections generally results in a well matched magic-tee. In the illustrated embodiment, the design exhibits a minimum of −20 dB return loss over 100 percent bandwidth at all waveguide ports 22a, 24a, 26a, and 28a.

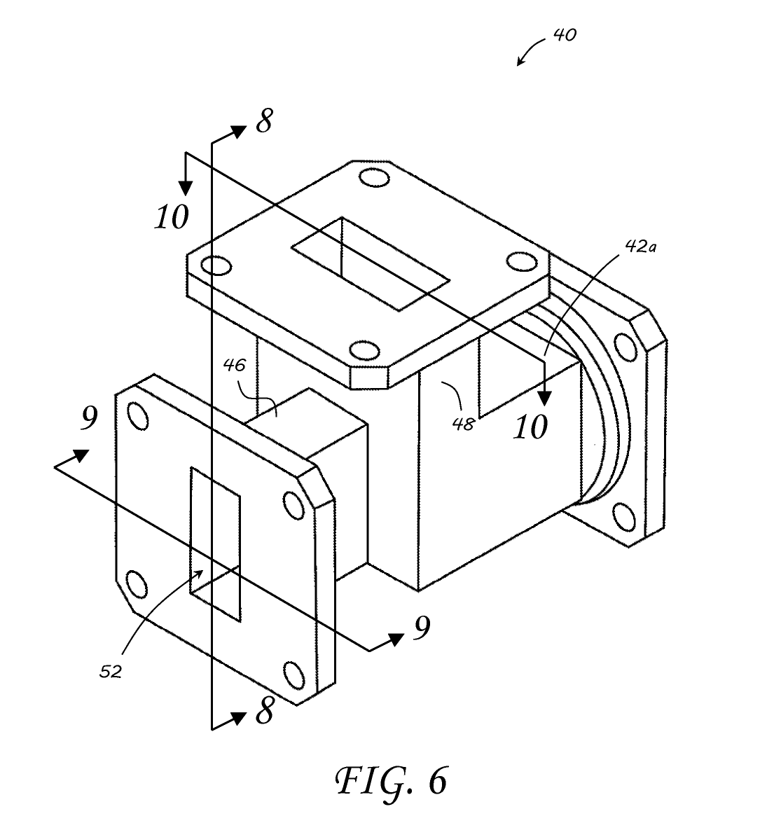

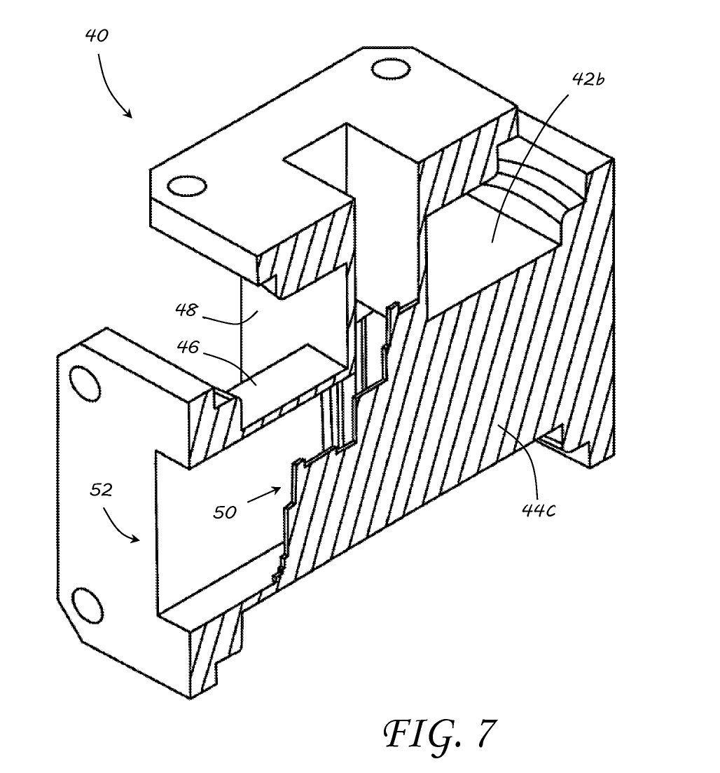

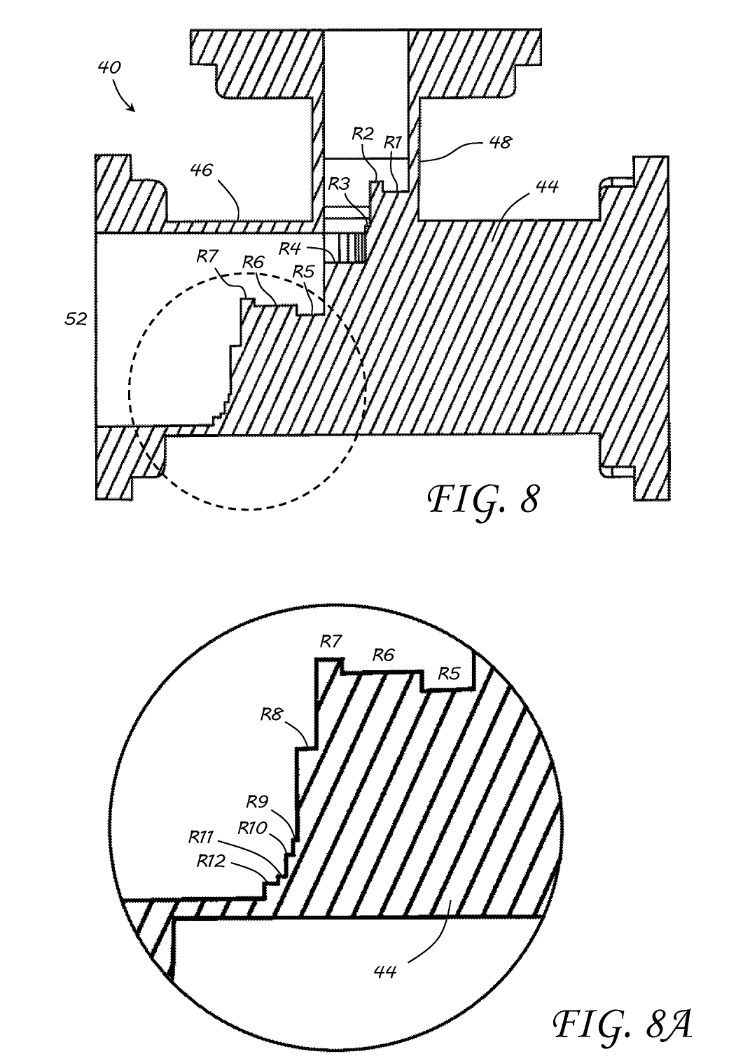

In an alternate embodiment, FIG. 6 illustrates a magic-tee 40 in an E-plane folded configuration. The folded E-Plane magic-tee is a variation of the magic-tee that was developed for microwave applications requiring higher power carrying capacities. This variation of the magic-tee is created by “folding” the opposing arms (for example arms 26 and 28 in FIG. 1) so that they are parallel to the E-arm. In the illustrated embodiment of the magic-tee 40 in FIG. 6, parallel, collinear arms 42a, 42b are separated by a bifurcating wall 44, which can be seen in FIG. 7. The bifurcating wall 44 extends into both the E-arm 46 and H-arm 48 with a stepped ridge profile 50. An impedance step from a standard waveguide 52 in the E-arm 46 to the stepped ridge profile 50 is gradual with a ridge height increasing with each step until step R7 with varied lengths for each step. Details of the stepped ridge profile 50 may be seen in various orientations in FIGS. 7, 8, 8A and 9. Dimensions of the stepped ridge profile normalized to a center frequency are set out the Table below:

TABLE 4
Frequency Normalized Stepped Ridge Dimensions

| Ridge | Frequency | Frequency |
|---|---|---|
| Step | Normalized Height | Normalized Width |
| R1 | 0.919307 | 1.076461 |
| R2 | 0.957734 | 0.048266 |
| R3 | 0.785263 | 0.022290 |
| R4 | 0.639852 | 0.164783 |
| R5 | 0.435898 | 0.103390 |
| R6 | 0.468137 | 0.169384 |
| R7 | 0.492055 | 0.048658 |
| R8 | 0.306490 | 0.043572 |
| R9 | 0.118567 | 0.003504 |
| R10 | 0.087042 | 0.016799 |
| R11 | 0.041295 | 0.013916 |
| R12 | 0.027346 | 0.030970 |

Coupling between the H-arm 48 and the symmetrical, collinear arms 42a, 42b may be further increased by step reductions in the stepped ridge 50 profile at steps R1 and R5. Additionally, stepped ridge 50 steps R1 and R2 effective act to a characteristic impedance of the rectangular waveguide and allow for broadband electric field propagation of a fundamental mode below a cutoff wavelength of the given rectangular waveguide.

A frequency normalized thickness T1 of the bifurcating wall 44 along the stepped ridge 50 is approximately 0.0254 between steps R1 and R12. A thickness T2 of a remainder of the bifurcating wall 44 is approximately twice the thickness T1, though in other embodiments, other wall thickness may also be appropriate for impedance matching. Additionally, other tapered or varying wall structures may also be used in other embodiments.

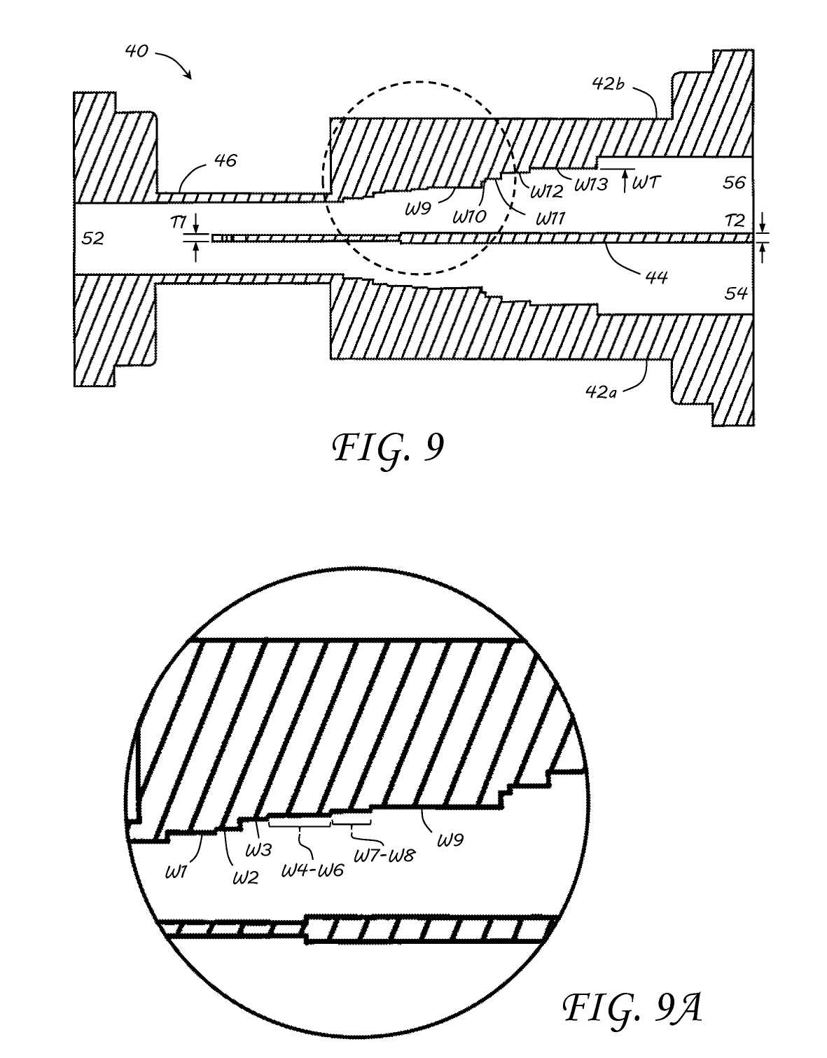

Outer solid walls from the E-arm 46 to the parallel, collinear arms 42a, 42b may be discontinuous, as illustrated in the exemplary embodiment 40, by cascaded wall steps of the waveguide height in a waterfall configuration. Details of the cascaded wall steps may be seen in various orientations in FIGS. 9 and 9A. Dimensions of the cascaded wall steps normalized to a center frequency are set out the Table below:

TABLE 5
Frequency Normalized Cascaded Wall Step Dimensions

| | Frequency | Frequency |
|---|---|---|
| Wall Step | Normalized Depth | Normalized Width |
| W1 | 0.019820 | 0.068219 |
| W2 | 0.001680 | 0.032576 |
| W3 | 0.021949 | 0.040768 |
| W4 | 0.005401 | 0.008466 |
| W5 | 0.004724 | 0.008983 |
| W6 | 0.003281 | 0.06913 |
| W7 | 0.002189 | 0.034216 |
| W8 | 0.000938 | 0.022355 |
| W9 | 0.001528 | 0.180520 |
| W10 | 0.022660 | 0.011357 |
| W11 | 0.022248 | 0.051054 |
| W12 | 0.019422 | 0.096117 |
| W13 | 0.015267131 | 0.225569 |

The final step WT of approximately 0.015267 (normalized to the center frequency) is held constant and is equivalent to the equivalent waveguide walls of waveguides 54, 56 in parallel, collinear arms 42a, 42b. The number of wall steps present may vary as geometrical dimensions scale to negligible proportion for a desired frequency band of operation and as necessitated by manufacturing tolerances. An effect of the waterfall step configuration is to transform an impedance between the E-arm 46 and the collinear arms 42a, 42b across the waveguide frequency band.

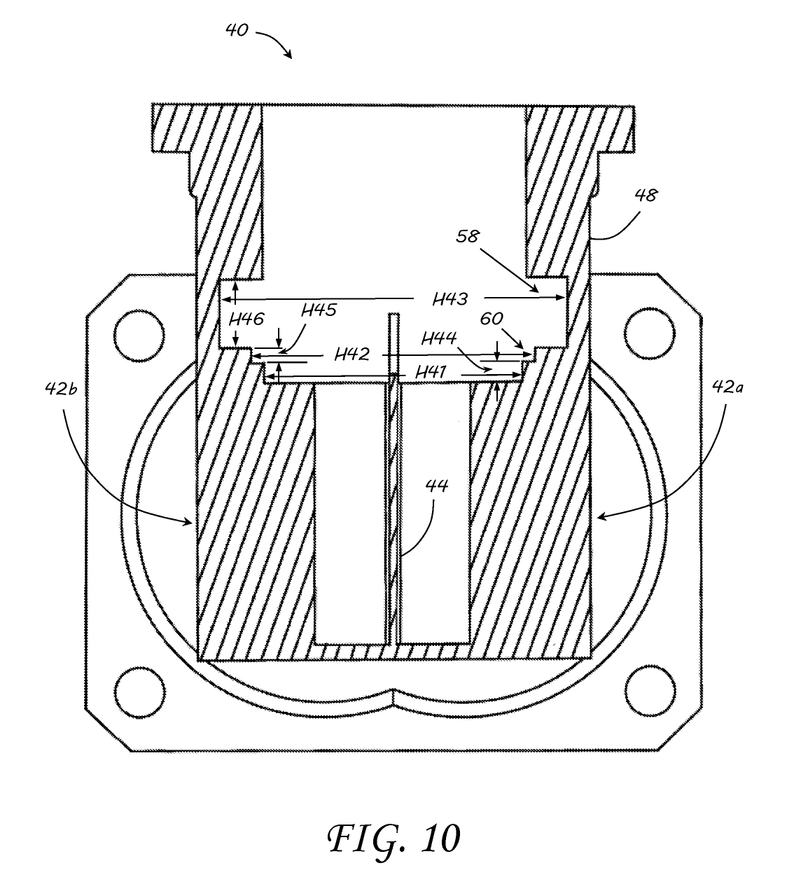

FIG. 10 illustrates a cross-section of the H-arm 48 including symmetrical, inductive window cavities 58, 60 situated above the stepped ridge profile 50 of the bifurcating wall 44. The stepped cavities act as an additional impedance transformer and assist in further reducing electric field reflections along the H-arm 48. Details of the cascaded wall steps may be seen in FIG. 10A. Dimensions of the cascaded wall steps normalized to a center frequency are set out the Table below:

TABLE 6
Frequency Normalized H-arm Cavity Dimensions

| H-arm Cavity | Frequency |
|---|---|
| Dimensions | Normalized Value |
| H41 | 0.741190 |
| H42 | 0.820355 |
| H43 | 1.000157 |
| H44 | 0.055650 |
| H45 | 0.042959 |
| H46 | 0.197666 |

Similar to the embodiment illustrated in FIG. 1, the waveguides in arms 42a, 42b, 46, and 48 in the illustrated embodiment in FIG. 6 are rectangular in cross section with dimensional ratio of approximately 2 to 1, though other embodiments may utilize waveguides having cross sections with alternate ratios, or cross sections that are not rectangular. The exact dimensions of the waveguides in arms 42a, 42b, 46 and 48 may be determined with respect to an excitation frequency such that a fundamental TE₁₀ mode may propagate in the waveguides. In the illustrated embodiment, the waveguides were designed for an excitation frequency of approximately 10 GHz.

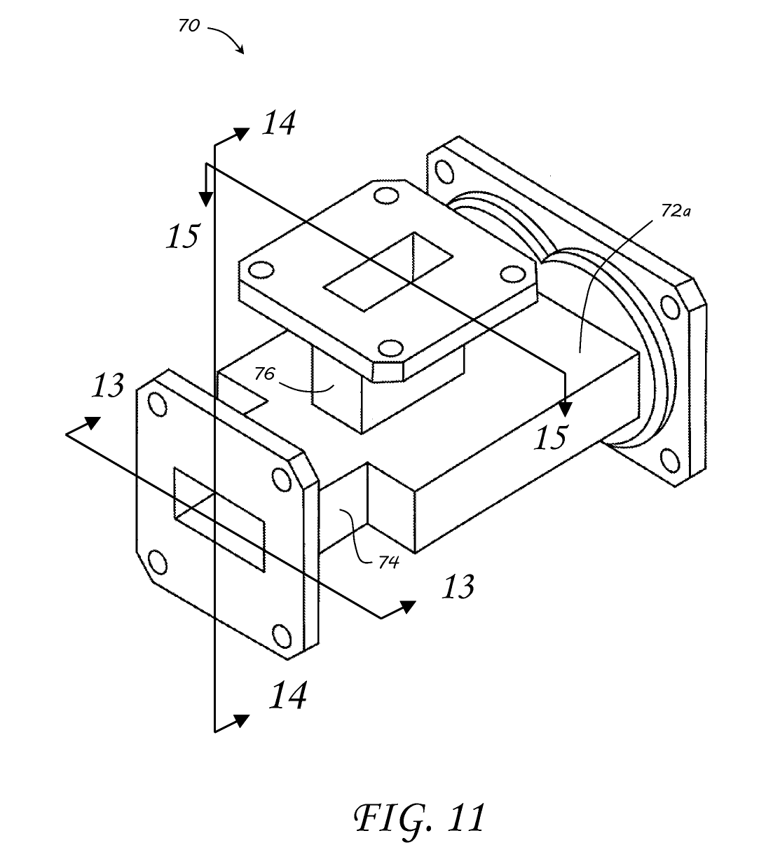

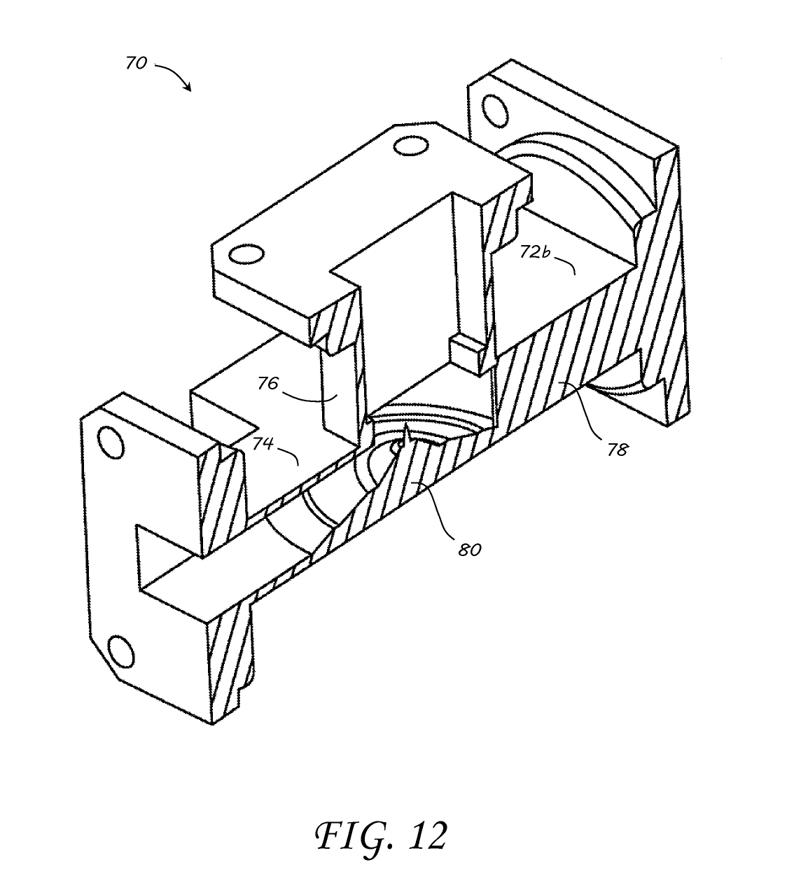

In an alternate embodiment, FIG. 11 illustrates a magic-tee 70 in an H-plane folded configuration. The folded H-Plane magic-tee is another variation of the magic-tee, which may be obtained by bending collinear arms 72a, 72b such that their centerlines are parallel to an H-arm 74. An E-arm 76 is positioned perpendicular to the H-arm 74 and collinear arms 72a, 72b similar to the embodiments set forth above. A common junction of the collinear, E- and H-arms 72a, 72b, 74, 76 may be bifurcated along a symmetry plane with a protruding common wall 78, additionally separating waveguides in the collinear arms. This common wall 78 extends partially into a stepped conducting cone 80 as illustrated in FIGS. 12, 13 and 14.

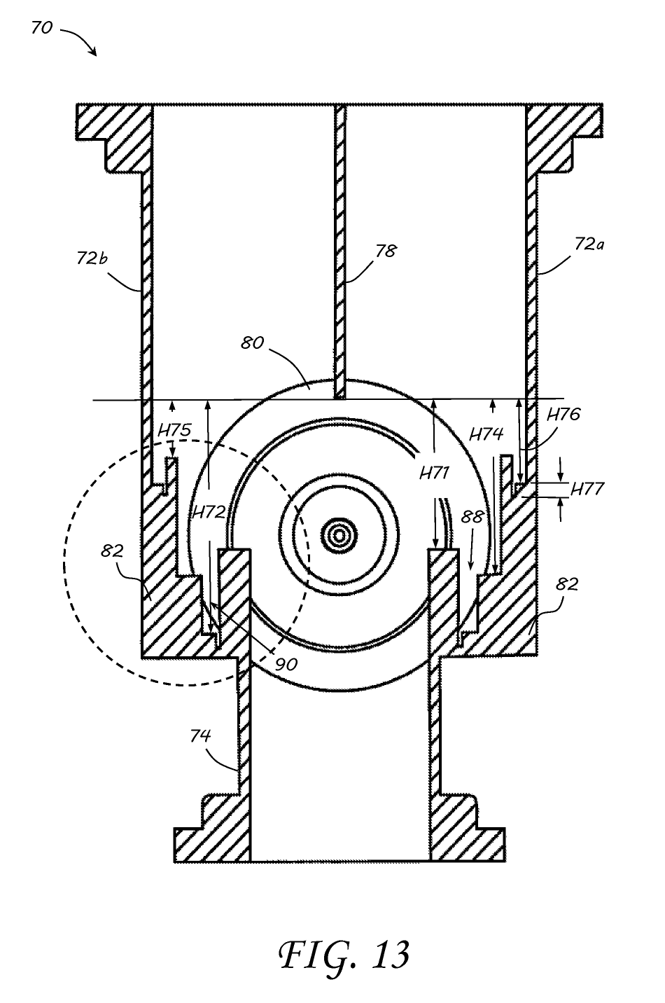

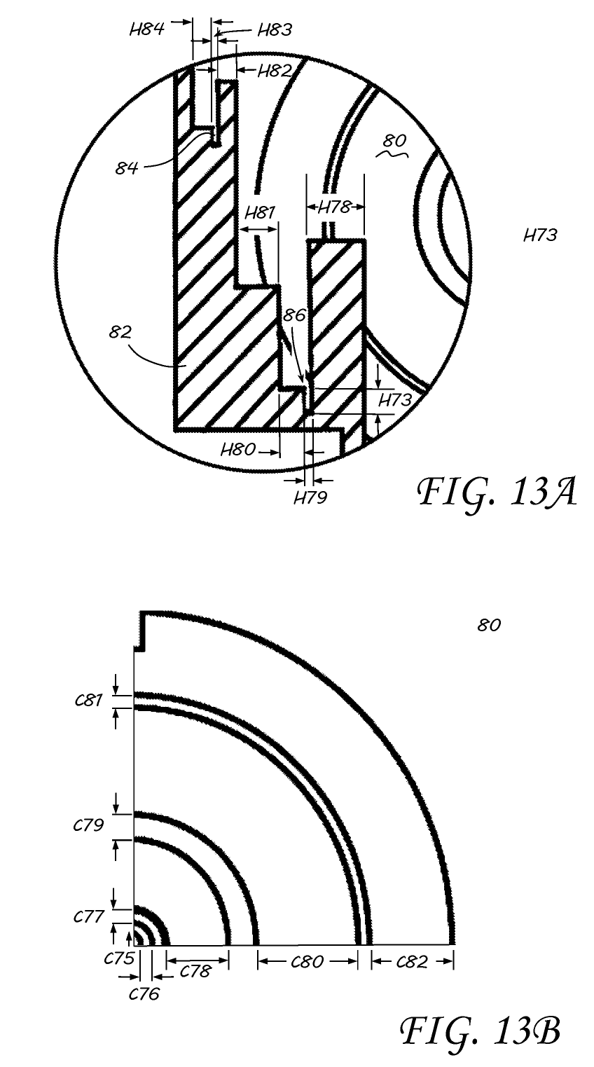

As seen in FIG. 13, an outer wall 82 is discontinuous including cascaded wall steps with offset cavities. Heights of the cavities in the illustrated embodiment 70 are held constant and equivalent to a height of the waveguide associated with the H-arm 74. Additional details of the offset cavities may be seen in FIG. 13A. Dimensions of the offset cavities normalized to a center frequency are set out the Table below:

TABLE 7
Frequency Normalized H-arm Offset Cavity Dimensions

| H-arm Offset | |
|---|---|
| Cavity | Frequency |
| Dimensions | Normalized Value |
| H71 | 0.476224 |
| H72 | 0.786804 |
| H73 | 0.046521 |
| H74 | 0.550502 |
| H75 | 0.114952 |
| H76 | 0.219614 |
| H78 | 0.042504 |
| H79 | 0.010418 |
| H80 | 0.130765 |
| H81 | 0.074616 |
| H82 | 0.104736 |
| H83 | 0.052090 |
| H84 | 0.039957539 |

Cavities 84 and 86 may be omitted in some embodiments as geometric dimensions scale to negligible proportions for desired operating frequency bands as well as necessitated by manufacturing tolerances. Additionally, in the illustrated embodiment 70, walls of cavities 88 and 90 partially protrude into the stepped conducting cone 80.

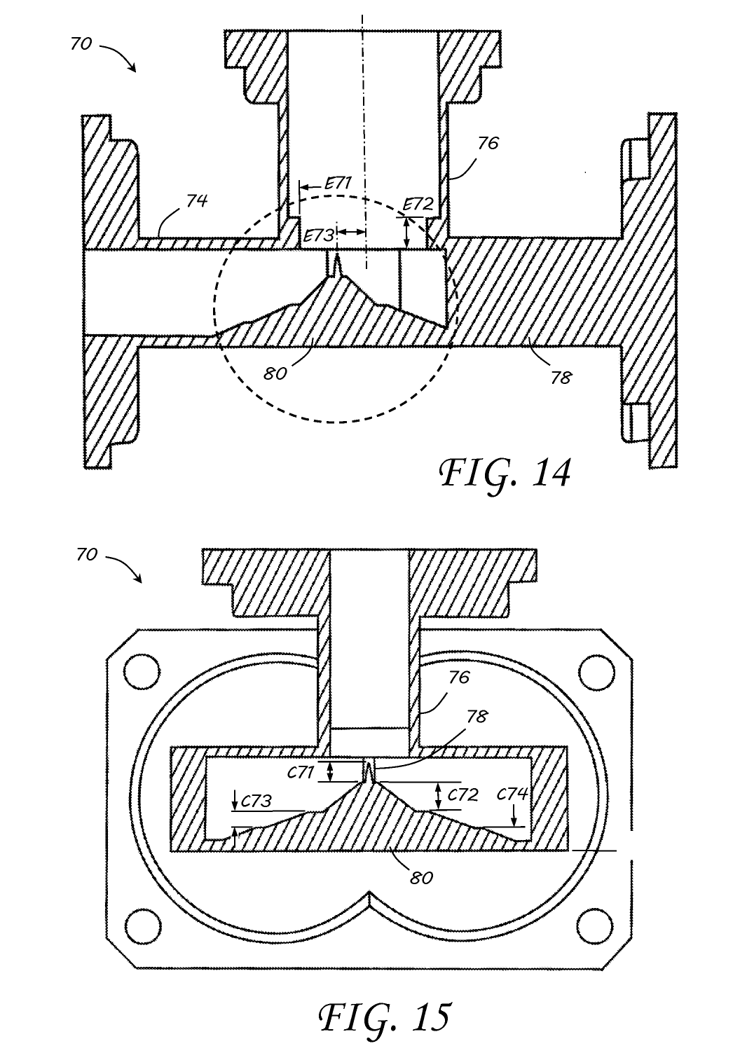

The E-arm 76 includes a symmetrical inductive window taper at a base of the E-arm 76 and flush with a top of the H-arm 74 and collinear arm 72a, 72b walls. The inductive taper runs the width of the E-arm 76 with additional dimensional values E71 and E72 normalized to the center frequency of 0.056045 and 0.121686 respectively. Additionally, as illustrated in FIG. 14, the stepped conducting cone 80 is placed offset from a center for the E-arm 76. This offset distance E73 is approximately 0.164394 though other offsets for other embodiments may also be used based on operating frequency ranges.

The stepped conducting cone 80 includes five cylindrical sections with each respective cone radius having a taper expanding from top to bottom with varied heights, similar to the stepped conducting cone 30 in the embodiment 20 set forth above. Dimensions of the stepped conducting cone 80 (C71-C84) normalized to a center frequency are set out the Table below:

TABLE 8
Frequency Normalized Stepped Conducting Cone Dimensions

| Cone Dimension | Frequency Normalized Value |
|---|---|
| C71 | 0.084826 |
| C72 | 0.118274135 |
| C73 | 0.065163 |
| C74 | 0.053276009 |
| C75 | 0.015964 |
| C76 | 0.022800 |
| C77 | 0.027981106 |
| C78 | 0.126389 |
| C79 | 0.051988 |
| C80 | 0.201330 |
| C81 | 0.016586 |
| C82 | 0.159286 |

In this exemplary embodiment, the stepped conducting cone 30 consists of five cylinders, though other embodiments may have more or fewer cylinders.

As with the other embodiments, this illustrated embodiment waveguides with rectangular cross sections with a dimensional ration of approximately 2 to 1. Again the exact dimensions of the waveguides are determined with respect to an excitation frequency such that a fundamental TE₀ mode may propagate the waveguides. The waveguides for all of the described embodiments are constructed from highly conductive materials, such as copper, brass or the like and have some minimum thickness for all outer walls of the waveguides based on an operational frequency and chosen material properties for the embodiment.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A hybrid tee waveguide structure comprising:
a first collinear arm having a first waveguide;
a second collinear arm having a second waveguide;
an H-arm having a third waveguide and including at least one window; and
an E-arm having a fourth waveguide and including at least one window, the E-arm oriented perpendicular to the H-arm,
wherein the first, second, third and fourth waveguides join at a common junction,
wherein the at least one window of the H-arm and the at least one window of the E-arm are proximate the common junction, and wherein the at least one window of the H-arm and the at least one window of the E-arm change an impedance of the common junction to reduce reflections in the H-arm and E-arm.

2. The hybrid tee waveguide structure of claim 1, further comprising:
an impedance matching element positioned in the common junction and extending toward the third waveguide,
wherein the impedance matching element is offset from a centerline of the E-arm and aligned with a centerline of the H-arm.

3. The hybrid tee waveguide structure of claim 2, wherein the impedance matching element comprises:
a plurality of cylinders of different radii tapering toward the third waveguide.

4. The hybrid tee waveguide structure of claim 3, wherein the impedance matching element consists of five cylinders.

5. The hybrid tee waveguide structure of claim 1, wherein the first and second collinear arms are oriented parallel to each other and parallel to the E-arm, the hybrid tee waveguide structure further comprising:
a bifurcating wall separating the first and second collinear arms.

6. The hybrid tee waveguide structure of claim 5, further comprising:
a stepped ridge profile extending from the bifurcating wall into the third waveguide in the H-arm and the fourth waveguide in the E-arm.

7. The hybrid tee waveguide structure of claim 5, further comprising:
outer solid walls of each of the first and second collinear arms having a discontinuity of cascaded wall steps in a waterfall configuration narrowing from waveguides associated with the first and second collinear arms toward the E-arm.

8. The hybrid tee waveguide structure of claim 1, wherein the first, second, third, and fourth waveguides have a rectangular cross section.

9. The hybrid tee waveguide structure of claim 6, wherein the rectangular cross section has a ratio of 2:1.

10. The hybrid tee waveguide structure of claim 1, wherein the first and second collinear arms are oriented parallel to each other and parallel to the H-arm.
